(19) United States
(12) Patent Application Publication
(10) Pub. No.: US 2021/0051949 A1
(43) Pub. Date: Feb. 25, 2021

(54) SOLID AGROCHEMICAL COMPOSITIONS

(71) Applicant: UPL LTD, Haldia (IN)

(72) Inventors: Bruna Mariele DE ALMEIDA, Mumbai (IN); Natalia Gonçalves, Mumbai (IN); Jaidev Rajnikant Shroff, Dubai (AE); Vikram Rajnikant Shroff, Dubai (AE)

(21) Appl. No.: 16/982,265

(22) PCT Filed: Mar. 6, 2019
(86) PCT No.: PCT/IB2019/051788

§ 371 Date: Sep. 18, 2020

(30) Foreign Application Priority Data
Mar. 29, 2018 (IN) 201831012029

(51) Int. Cl. A01N 25/08; A01N 43/40; A01N 57/20; A01N 47/36; A01N 39/04

(52) U.S. Cl. CPC A01N 25/08; A01N 43/40; A01N 39/04; A01N 47/36; A01N 57/20

(57) ABSTRACT

The present invention relates to solid herbicidal compositions. Particularly the present invention relates to solid herbicidal compositions comprising one or more electrolytic herbicides, one or more other herbicides and a base for controlling weeds.

### FIELD OF THE INVENTION

The present invention relates to solid herbicidal compositions. Particularly the present invention relates to solid herbicidal compositions comprising one or more electrolytic herbicides, one or more other herbicides and a base for controlling weeds.

### BACKGROUND OF THE INVENTION

To develop weed management programs which are effective as well as capable of addressing the resistance development related concerns is becoming a challenge. In the present scenario of herbicide resistant development, it requires greater attention to herbicide selection and application rates compared with older methods. Further, due to environmental concerns in society and political regulatory framework, the quantity of herbicides used has to be decreased. To address such important issues, wise usage of herbicides is recommended. It is important to use a broad-spectrum herbicide program including herbicides having different modes of action for season-long effective weed control and to avoid shifts toward problematic weed species or evolution of herbicide-resistant weed biotypes. However selection of appropriate mixture partners requires a greater understanding about their interactions with each other and compatibility and stability parameters are to be checked.

2,4-D, an electrolytic herbicide is one of the oldest and most widely available herbicides. It is a selective systemic herbicide. 2,4-D is a strong acid and forms water-soluble salts with alkali metals and amines. Most of the marketed products are in the form of salts or esters. Salts are readily absorbed by the roots, whilst esters are readily absorbed by the foliage. Translocation occurs, with accumulation principally at the meristematic regions of shoots and roots. Commonly, it is used for post-emergence control of annual and perennial broad-leaved weeds in cereals, maize, sorghum, grassland, established turf, grass seed crops, orchards (pome fruit and stone fruit), cranberries, asparagus, sugar cane, rice, forestry, and on non-crop land (including areas adjacent to water). Control of broad-leaved aquatic weeds. However, 2,4-D based products are not effective for control of various species of grasses.

Picloram is another electrolytic herbicide which is further classified as a pyridine carboxylic acid herbicide. Picloram is a selective systemic herbicide, absorbed rapidly by the roots and leaves, and translocated both acropetally and basipetally, accumulating in new growth. It also controls a wide range of broad-leaved weeds, but most grasses are resistant. The main use of picloram salts and esters is for the management of unwanted vegetation in rangeland, grass pastures, forestry, as well as non-crop land and rights-of-way sites such as around industrial and military installations, roads, railways, airports, under powerlines and along pipelines. In some countries, there are additional uses in rice, sugar cane, cereals and oilseed rape. When picloram is formulated as a stand-alone product, it is typically as the potassium salt. When in combination with other active ingredients, picloram is formulated either as an ester or an amine salt.

Tryclopyr is another pyridine carboxylic acid herbicide. It is a selective systemic herbicide, rapidly absorbed by the foliage and roots, with translocation throughout the plant, accumulating in meristematic tissue. It induces auxin-type responses in susceptible species (mainly broad-leaved weeds, grass weeds being unaffected at normal application rates). It is widely used for controlling of woody plants and many broad-leaved weeds (e.g. nettles, docks, brambles, gorse, broom) in grassland, uncultivated land, industrial areas, coniferous forests, plantation crops, and rice fields.

Metsulfuron methyl is a sufonylurea herbicide which affects sensitive weeds through inhibition of the enzyme acetolactate synthase (ALS). Inhibition of ALS leads to the rapid cessation of cell division and subsequent growth processes in plants. Selective systemic herbicide absorbed through the roots and foliage and translocated to the apex of the plants. Symptoms appear within days, with death within 2-4 weeks. Controls a wide range of grass and broad-leaved weeds in wheat, barley, rice, oats and triticale by post-emergence application.

Electrolytic herbicides like 2,4-D and picloram are highly effective for controlling a wide range of broad-leaved weeds, however observed to be not that effective in controlling grasses and sedges. On the contrary, sulfonyl urea herbicides such as metsulfuron methyl is observed to be very effective for the various grass varieties as well.

Inventors of the present invention noted that as the electrolytic herbicides are insoluble in water, the corresponding water soluble salts are commonly employed as aqueous based formulations. However, when an aqueous based formulation for the combination of electrolytic herbicides with sulfonyl urea herbicide is developed, incompatibility issues were observed. It has been observed that metsulfuron methyl (for example) is water sensitive and is tempted to degrade when exposed to aqueous environments.

Accordingly, it is desirable to develop compositions and processes comprising combinations of above-mentioned herbicides that can be used for broad spectrum weed control.

Above mentioned type of electrolytic herbicides can be formulated into a variety of different forms preferably into liquid compositions. However solid formulations are the choice when such active ingredients are to be combined with water sensitive active ingredients and/or with active ingredients in liquid form.

The present invention provides a novel method of preparing compositions comprising above mentioned active ingredients with electrolytic herbicides which are stable as well as provides desired bio efficacy.

Embodiments of the present invention may therefore ameliorate one or more of the above mentioned problems:

### OBJECTS OF THE INVENTION

It is an object of the invention to provide herbicidal compositions comprising one or more electrolytic herbicides, one or more other herbicides and a base for controlling weeds.

It is another object of the invention to provide a novel process for preparing herbicidal compositions comprising one or more electrolytic herbicides, one or more other herbicides and a base.

Yet another object of the present invention is to provide a method of controlling unwanted plants using herbicidal compositions comprising one or more electrolytic herbicides, one or more other herbicides and a base.

### SUMMARY OF THE INVENTION

A solid composition comprising:
a) at least one electrolytic herbicide;
b) at least another herbicide; and
c) a base in an amount sufficient enough to solubilize component a) during dilution.

The present invention further provides a solid herbicidal composition comprising:
a) at least one electrolytic herbicide;
b) at least another herbicide selected from the group consisting of pyridine carboxylic acid herbicides, organophosphorus herbicides and sulfonyl urea herbicides; and
c) a base in an amount sufficient enough to solubilize component a) during dilution.

A process for preparing solid compositions comprising at least one electrolytic herbicide in combination with at least another herbicide, said process comprising using a base, within the composition, in an amount sufficient to solubilize said electrolytic herbicides during dilution.

The invention further provides a process for preparing solid herbicidal composition comprising:
a) preparing a mixture of
   i) at least one electrolytic herbicide;
   ii) at least another herbicide selected from the group consisting of pyridine carboxylic acid herbicides, organophosphorus herbicides and sulfonyl urea herbicides;
   iii) a base in an amount sufficient to solubilize component i) during dilution;
   iv) optionally other agrochemical excipients; and
b) adding water to make the mixture extrudable; and
c) extruding the mixture.

The present invention further provides a method of controlling unwanted plants, said method comprising applying to the unwanted plants or to their locus a herbicidally effective amount of compositions according to the present invention.

Further the invention provides a method of controlling unwanted plants in pasture lands, said method comprising applying to the unwanted plants or to their locus a herbicidally effective amount of compositions according to the present invention.

### DETAILED DESCRIPTION OF THE INVENTION

The term herbicide, as used herein, shall mean an active ingredient that kills, controls or otherwise adversely modifies the growth of plants. As used herein, a herbicidally effective or vegetation controlling amount is an amount of active ingredient that causes a “herbicidal effect,” i.e., an adversely modifying effect and includes deviations from natural development, killing, regulation, desiccation, or retardation. The terms “plants” and “vegetation” include, but are not limited to, germinant seeds, emerging seedlings, plants emerging from vegetative propagules, and established vegetation. The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus.

“Electrolytic”, as used herein, means capable of creating an aqueous solution during dilution containing free ions that behaves as an electrically conductive medium.

“Compatibilize” as used herein means no degradation of active herbicidal ingredient on storage.

“Solubilize” as used herein means having a solubility sufficient to enable the electrolytic herbicide to be dissolved completely in the aqueous phase during dilution at the desired concentration. The term “solubilize” further involves reaction, neutralization or partial neutralization in a way sufficient to enable the electrolytic herbicide to be dissolved completely in the aqueous phase during dilution at the desired concentration.

It has been observed by the inventors of the present invention that herbicides such as sulfonamide herbicides that are incompatible in liquid formulations particularly aqueous formulations with electrolytic herbicides can be formulated into stable solid herbicidal compositions using a suitable granulation process wherein the process comprises use of an inorganic base in an amount sufficient to solubilize the electrolytic herbicides during dilution.

Surprisingly, it has been found out that electrolytic herbicides can be formulated in combination with moisture sensitive sulfonamide herbicides into stable solid herbicidal compositions wherein said compositions comprise a base in an amount sufficient to solubilize the electrolytic herbicides during dilution. It has been further noted that compatibilized compositions can be developed by the process according to the present invention.

It has been further noted by the inventors that electrolytic herbicides can be formulated in combination with liquid water insoluble pyridine carboxylic acid herbicides into stable solid herbicidal compositions wherein said compositions comprise a base in an amount sufficient to solubilize the electrolytic herbicides during dilution.

It was surprisingly found that the use of such bases, preferably inorganic bases, led to an unexpected increase in the herbicidal efficacy of the compositions of the present invention. It was seen that, in the absence of the base, preferably the inorganic base, the herbicidal efficacy of the composition comprising an electrolytic herbicide along with the other herbicides of the invention significantly dropped from the efficacy seen when the inorganic base was used. It was thus concluded that the enhanced herbicidal efficacy of the compositions according to the present invention could be attributed, at least partially, to the presence of the base, preferably an inorganic base, within the compositions of the present invention.

Accordingly the present invention provides a herbicidal composition comprising:
a) at least one electrolytic herbicide;
b) at least another herbicide; and
c) a base in an amount sufficient to solubilize component a) during dilution.

In an embodiment, the base is selected from an organic base or an inorganic base.

In a one embodiment, the base is an inorganic base.

In a one embodiment, the base is an organic base.

Thus, in one embodiment, the present invention provides a herbicidal composition comprising:
a) at least one electrolytic herbicide;
b) at least another herbicide; and
c) an inorganic base in an amount sufficient to solubilize component a) during dilution.

In any embodiment described herein, the compositions of the present invention may optionally comprise other agrochemical excipients.

In an embodiment, the present invention provides a solid herbicidal formulation comprising:
a) at least one electrolytic herbicide;
b) at least another herbicide selected from the group consisting of pyridine carboxylic acid herbicides, organophosphorus herbicides and sulfonyl urea herbicides; and
c) an inorganic base in an amount sufficient to solubilize component a) during dilution.

In another embodiment, the present invention provides a solid herbicidal formulation comprising:
a) at least two electrolytic herbicides;
b) at least another herbicide selected from the group consisting of pyridine carboxylic acid herbicides, organophosphorus herbicides and sulfonyl urea herbicides; and
c) an inorganic base in an amount sufficient to solubilize component a) during dilution.

In an embodiment of the present invention, there is provided a solid herbicidal composition comprising:
a) at least one electrolytic herbicide;
b) at least one organophosphorus herbicide or its derivatives; and
c) an inorganic base in an amount sufficient enough to solubilize component a) during dilution.

In an embodiment of the present invention, there is provided a solid herbicidal composition comprising:
a) at least one electrolytic herbicide;
b) at least one pyridine carboxylic acid herbicide or their derivatives; and
c) an inorganic base in an amount sufficient to solubilize component a) during dilution.

In another embodiment of the present invention, there is provided a solid herbicidal composition comprising:
a) at least one electrolytic herbicide;
b) at least one sulfonyl urea herbicide or their derivatives; and
c) an inorganic base in an amount sufficient enough to solubilize component a) during dilution.

In an embodiment of the present invention, the electrolytic herbicide is selected from the group comprising phenoxyacetic acid herbicides, phenoxybutyric acid herbicides, phenoxypropionic herbicides and pyridine carboxylic acid herbicides.

In one embodiment of the present invention, the electrolytic herbicide is selected from phenoxyacetic acid herbicides and pyridine carboxylic acid herbicides.

In one embodiment of the present invention, the electrolytic herbicide is selected from phenoxyacetic acid herbicides.

In one embodiment of the present invention, the phenoxyacetic acid herbicides is used in an amount of about 1-50% w/w of the total composition.

In one embodiment of the present invention, the phenoxyacetic acid herbicides is used in an amount of about 1-40%.

In another preferred embodiment of the present invention, the phenoxyacetic acid herbicide is 2,4-dichlorophenoxy acetic acid.

In one embodiment of the present invention, the electrolytic herbicide is pyridine carboxylic acid herbicides.

In one embodiment of the present invention, the pyridine carboxylic acid herbicides is used in an amount of about 0.1-30%.

In one embodiment of the present invention, the pyridine carboxylic acid herbicides is used in an amount of about 1 to 20%.

In some embodiments of the present invention the other herbicides are selected from pyridine carboxylic acid herbicides, organophosphorus herbicides, their derivatives and sulfonyl urea herbicides.

In some other embodiments of the present invention other herbicides are selected from pyridine carboxylic acid herbicides or their derivatives in liquid state.

In some other embodiments of the present invention other herbicide is pyridine carboxylic acid herbicide.

In a preferred embodiment, the pyridine carboxylic acid herbicide is selected from esters of pyridine carboxylic acid herbicides.

In one embodiment of the present invention, the esters of pyridine carboxylic acid herbicides is used in an amount of about 0.1-30%.

In one embodiment of the present invention, the esters of pyridine carboxylic acid herbicides is used in an amount of about 1-20%.

In a most preferred embodiment, the pyridine carboxylic acid herbicide is tryclopyr butotyl.

In some embodiments, of the present invention other herbicides are selected from organophosphorus herbicides.

In one embodiment of the present invention, the organophosphorus herbicides is used in an amount of about 1-50% w/w.

In one embodiment of the present invention, the organophosphorus herbicides is used in an amount of about 1-40% w/w.

In some other embodiments, the organophoshorus herbicide according the compositions of the present invention is selected from glufosinate, glufosinate-P, glyphosate and their derivatives such as salts and esters.

In some other embodiments, the organophoshorus herbicide according the compositions of the present invention is selected from water soluble salts of organophosphorus herbicides.

In a preferred embodiment, the organophoshorus herbicide is selected from glufosinate and their derivative compounds such as salts and esters.

In some embodiments, the sulfonyl urea herbicide according the compositions of the present invention is selected from amidosulfuron, azimsulfuron, bensulfuron, chlorimuron, cyclosulfamuron, halosulfuron, ethoxysulfuron, flazasulfuron, flucetosulfuron, flupyrsulfuron, foramsulfuron, imazosulfuron, mesosulfuron, metazosulfuron, methiopyrisulfuron, monosulfuron, nicosulfuron, orthosulfamuron, oxasulfuron, propyrisulfuron, primisulfuron, pyrazosulfuron, rimsulfuron, sulfometuron, sulfosulfuron, trifloxysulfuron, zuomihuanglong, chlorsulfuron, cinosulfuron ethametsulfuron, iodosulfuron, iofensulfuron, metsulfuron, prosulfuron, thifensulfuron, triasulfuron, tribenuron, triflusulfuron, tritosulfuron, buthiuron ethidimuron, tebuthiuron, thiazafluron, thidiazuron and their derivatives.

In one embodiment of the present invention, the sulfonyl urea herbicide is used in an amount of about 0.1-30%.

In one embodiment of the present invention, the sulfonyl urea herbicide is used in an amount of about 1 to 20%.

In a preferred embodiment the sulfonyl urea herbicide according to the compositions of the present invention is metsulfuron methyl.

In certain other embodiments the compositions according to the present invention comprises an inorganic base.

In certain embodiments, the inorganic base according to the compositions of the present invention is required in an amount sufficient to solubilize the electrolytic herbicides during dilution.

In some embodiments, the inorganic base according to the compositions of the present invention is required in an amount from about 5% to about 95% by weight of the composition.

In certain other embodiments of the present invention, the inorganic base according to the invention comprises bases having cations derived from alkali metals or ammonium and counter ions selected from but are not limited to carbonate, phosphate, hydroxide etc.

In an embodiment, the inorganic base includes but are not limited to sodium carbonate, sodium phosphate, sodium hydrogen phosphate, sodium hydroxide, potassium carbonate, potassium phosphate, potassium hydrogen phosphate, potassium hydroxide, ammonium carbonate, ammonium phosphate, ammonium hydrogen phosphate, ammonium hydroxide etc.

In an embodiment the present invention provides a solid composition comprising:
a) 2,4-D acid
b) picloram acid
c) metsulfuron-methyl and
d) base

In an embodiment the present invention provides a solid composition comprising:
a) 2,4-D acid
b) picloram acid
c) triclopyr butotyl and
d) a base

In an embodiment the present invention provides a solid composition comprising:
a) 2,4-D acid
b) glufosinate ammonium and
c) a base

In an embodiment the present invention provides a solid composition comprising:
a) 2,4-D acid
b) picloram acid
c) metsulfuron-methyl and
d) a base

In an embodiment the present invention provides a solid composition comprising:
a) 2,4-D acid
b) picloram acid
c) triclopyr butotyl and
d) a base

In an embodiment the base is preferably selected from the group consisting of dibasic ammonium phosphate, sodium hydrogen phosphate and potassium phosphate,

In any of the embodiments described herein, the solid compositions according to the present invention optionally comprises other agrochemical excipients.

In certain embodiments, the solid compositions of the present invention comprises one or more excipients selected from auxiliary adjuvants/surfactants such as wetting agents spreading agents, penetration aids, dispersing agents and other agronomically suitable excipients such as carriers, fertilizer such as urea and ammonium sulfate, sticking and binding agents such as sugar, lignin and their derivatives, polyvinyl pyrrolidone, starch, natural gum such as xanthan gum, guar gum, carboxy methyl cellulose and their derivatives, inert ingredients, pH modifiers, suspending agents, spray droplet modifiers, pigments, antioxidants, UV protectants, compatibilizing agents, antifoam agents, sequestering agents, neutralizing agents, corrosion inhibitors, dyes, odorants, micronutrients, emollients, lubricants, and the like.

In an embodiment of the present invention, the adjuvants/surfactants are selected from anionic, cationic or zwitterionic or nonionic surface-active compounds.

Examples of anionic surfactants include: anionic derivatives of fatty alcohols having 10-24 carbon atoms in the form of ether carboxylates, sulfonates, sulfates, and phosphates, and their inorganic salts (e.g., alkali metal and alkaline earth metal salts) and organic salts (e.g., salts based on amine or alkanolamine); anionic derivatives of copolymers consisting of EO(ethylene oxide), PO (propylene oxide) and/or BO (butylene oxide) units, in the form of ether carboxylates, sulfonates, sulfates, and phosphates, and their inorganic salts (e.g., alkali metal and alkaline earth metal salts) and organic salts (e.g., salts based on amine or alkanolamine); derivatives of alkylene oxide adducts of alcohols, in the form of ether carboxylates, sulfonates, sulfates and phosphates, and their inorganic salts (e.g., alkali metal and alkaline earth metal salts) and organic salts (e.g., salts based on amine or alkanolamine); derivatives of fatty acid alkoxylates, in the form of ether carboxylates, sulfonates, sulfates and phosphates, and their inorganic salts (e.g., alkali metal and alkaline earth metal salts) and organic salts (e.g., salts based on amine or alkanolamine).

Examples of cationic or zwitterionic surfactants may be selected from alkylene oxide adducts of fatty amines, quaternary ammonium compounds having 8 to 22 carbon atoms (C8-C22), surface-active zwitterionic compounds such as taurides, betaines and sulfobetaines.

Examples of nonionic surfactants which may be used are: fatty alcohols having 10-24 carbon atoms with 0-60 EO and/or 0-20 PO and/or 0-15 BO in any order; fatty acid alkoxylates and triglyceride alkoxylates; fatty acid amide alkoxylates; alkylene oxide adducts of alkynediols; sugar derivatives such as amino sugars and amido sugars, alkyl polyglycosides; polyacrylic and polymethacrylic derivatives; polyamides such as modified gelatins or derivatized polyaspartic acid; polyvinyl compounds such as modified PVP; polyol-based alkylene oxide adducts; polyglycerides and derivatives thereof.

The solid compositions of the present invention thus stable and exhibited excellent weed control.

The present invention further provides a process for preparing solid compositions of electrolytic herbicides in combination with other herbicides wherein said process comprises using an inorganic base in an amount sufficient to solubilize said electrolytic herbicides during dilution.

In an embodiment, the present invention provides a suitable process for preparing solid compositions of electrolytic herbicides in combination with other herbicides selected from pyridine carboxylic acid or their derivatives, organophosphorus herbicides or their derivatives or sulfonyl urea herbicide or their derivatives wherein said process comprises using an inorganic base in an amount sufficient to solubilize said electrolytic herbicides during dilution.

The invention further provides a process for preparing solid herbicidal composition comprising:
a) preparing a mixture of
   i) one or more electrolytic herbicides;
   ii) one or more other herbicides selected from the group comprising pyridine carboxylic acid herbicides, organophosphorus herbicides and sulfonyl urea herbicides;
   iii) an inorganic base in an amount sufficient enough to solubilize component i) during dilution;
   iv) optionally other agrochemical excipients;
b) adding sufficient water to make the mixture extrudable; and
c) extruding the mixture using a suitable extruder.

In another embodiment of the present invention, there is provided a process for preparing solid herbicidal composition comprising:
a) preparing a mixture of
   i) one or more electrolytic herbicides;
   ii) one or more pyridine carboxylic acid herbicides or their derivatives;
   iii) an inorganic base in an amount sufficient enough to solubilize component i) during dilution;
iv) optionally other agrochemical excipients;
   b) adding sufficient water to make the mixture extrudable; and
   c) extruding the mixture using a suitable extruder.

In another embodiment of the present invention, there is provided a process for preparing solid herbicidal composition comprising:
a) preparing a mixture of
   i) one or more electrolytic herbicides;
   ii) one or more organophosphorus herbicides or their derivatives;
   iii) an inorganic base in an amount sufficient enough to solubilize component i) during dilution;
   iv) optionally other agrochemical excipients;
b) adding sufficient water to make the mixture extrudable; and
c) extruding the mixture using a suitable extruder.

In yet another embodiment of the present invention, there is provided a process for preparing solid herbicidal composition comprising:
a) preparing a mixture of
   i) one or more electrolytic herbicides;
   ii) one or more sulfonyl urea herbicide or their derivatives;
   iii) an inorganic base in an amount sufficient enough to solubilize component i) during dilution;
   iv) optionally other agrochemical excipients;
b) adding sufficient water to make the mixture extrudable; and
c) extruding the mixture using a suitable extruder.

In some embodiments of the present invention, the electrolytic herbicide is selected from the group comprising phenoxyacetic acid herbicides, phenoxybutyric acid herbicides, phenoxypropionic acid herbicides and pyridine carboxylic acid herbicides.

In certain embodiments of the present invention, other herbicides are selected from sulfonyl urea herbicides and pyridine carboxylic acid herbicides and their derivatives.

In some embodiments of the present invention other herbicide is selected from esters of pyridine carboxylic acid herbicides.

In some embodiments, the sulfonyl urea herbicide according the present invention is selected from amidosulfuron, azimsulfuron, bensulfuron, chlorimuron, cyclosulfamuron, halosulfuron, ethoxysulfuron, flazasulfuron, flucetosulfuron, flupyrsulfuron, foramsulfuron, imazosulfuron, mesosulfuron, metazosulfuron, methiopyrisulfuron, monosulfuron, nicosulfuron, orthosulfamuron, oxasulfuron, propyrisulfuron, primisulfuron, pyrazosulfuron, rimsulfuron, sulfometuron, sulfosulfuron, trifloxysulfuron, zuomihuanglong, chlorsulfuron, cinosulfuron, ethametsulfuron, iodosulfuron, iofensulfuron, metsulfuron, prosulfuron, thifensulfuron, triasulfuron, tribenuron, triflusulfuron, tritosulfuron, buthiuron ethidimuron, tebuthiuron, thiazafluron and thidiazuron.

In certain other embodiments of the invention, the inorganic base according to the process of the invention comprises a base having cations derived from alkali metals or ammonium and counter-ions selected from carbonate, phosphate, hydroxide etc. Examples of inorganic base include but are not limited to sodium carbonate, sodium phosphate, sodium hydrogen phosphate, sodium hydroxide, potassium carbonate, potassium phosphate, potassium hydrogen phosphate, potassium hydroxide, ammonium carbonate, diammonium phosphate, ammonium hydrogen phosphate, ammonium hydroxide etc.

In certain embodiments, the inorganic base used in the process according to the present invention is required in an amount sufficient enough to solubilize the electrolytic herbicides during dilution.

In some embodiments, the inorganic base used in the process according to the present invention is required in an amount from about 5% to about 60% by weight of the composition.

In some embodiments, according to the process of the present invention, water is added in the process in an amount sufficient to make the mixture extrudable.

In certain embodiments, according to the process of the present invention, water is added in the process in an amount sufficient to make the mixture in the form of dough or a paste which is further extrudable.

In certain embodiments according to the process of the present invention, water is added in the process in an amount which is less than 15% by weight of the composition.

In certain preferred embodiments according to the process of the present invention, water is added in the process in an amount which is less than 10% by weight of the composition.

In an embodiment, according to the process of the present invention extrusion is carried out by passing the mixture in the form of dough or paste through an extruder to produce extrudate.

Examples of extruders include, but are not limited to basket extruders, radial extruders etc.

In an embodiment, according to the process of the present invention, the extrudate is optionally subjected to conventional drying process.

The compositions according to the present invention can further contain one or more other active ingredients. The composition can be prepared by tank-mixing with other actives or alternatively may be sold as a kit of parts containing actives and other ingredients that may be mixed prior to spraying or a ready mix kit of parts containing premixed ingredients and actives.

Accordingly, in an embodiment, the present invention provides a kit of parts comprising a plurality of components to be mixed as instructed for being used in herbicidal control, wherein the plurality of components comprise a plurality of ingredients of the compositions of the present invention described hereinabove. In an embodiment, the plurality of ingredients may be mixed prior to spraying or a ready mix kit of parts containing premixed ingredients and actives may be prepared.

In an embodiment, one component of the kit of parts comprises instructions for preparing a mixture of the components of the composition.

In an embodiment, one component of the kit of parts comprises solid herbicidal compositions comprising:
a) one or more electrolytic herbicide;
b) one or more other herbicides; and
c) an inorganic base in an amount sufficient enough to solubilize component a) during dilution.

In another embodiment, another component of the kit of parts comprises one or more electrolytic herbicides.

In another embodiment, another component of the kit of parts comprises one or more other herbicides selected from the group comprising pyridine carboxylic acid herbicides, organophosphorus herbicides and sulfonyl urea herbicides.

In another embodiment, one component of the kit of parts comprises an inorganic base in an amount sufficient enough to solubilize one or more electrolytic herbicide of the composition during dilution.

In another embodiment, one component of the kit of parts comprises other agrochemical excipients.

In one embodiment, the kit of parts instructs the components of the kit to be applied concurrently, prior or subsequently to another component of the kit.

In another embodiment, the kit of parts instructs the components of the kit to be applied repeatedly at the site of the infection at predetermined time intervals.

In another embodiment, the electrolytic herbicide, one or more other herbicides selected from the group comprising pyridine carboxylic acid herbicides, organophosphorus herbicides and sulfonyl urea herbicides, and the inorganic base components are instructed to be tank-mixed or pre-formulated and then mixed.

In another embodiment, the other active ingredients that can be included in the compositions according to the present invention is selected from the group comprising herbicides, plant growth regulators, herbicide safeners, fungicides, and insecticides.

In certain preferred embodiment, the other active ingredients are selected from herbicides or herbicide safeners.

The present invention further provides provided a method of controlling unwanted plants, said method comprising applying to the unwanted plants or to their locus a herbicidally effective amount of solid herbicidal compositions comprising:
a) one or more electrolytic herbicide;
b) one or more other herbicides; and
c) an inorganic base in an amount sufficient enough to solubilize component a) during dilution.

In an embodiment, the electrolytic herbicide is selected from the group comprising phenoxyacetic acid herbicides, phenoxybutyric acid herbicides, phenoxypropionic herbicides and pyridine carboxylic acid herbicides.

In a preferred embodiment of the present invention, the electrolytic herbicide is selected from phenoxyacetic acid herbicides and pyridine carboxylic acid herbicides.

In another preferred embodiment of the present invention, the phenoxyacetic acid herbicide is 2,4-dichlorophenoxy acetic acid.

In some embodiments of the present invention other herbicides are selected from pyridine carboxylic acid herbicides, organophosphorus herbicides, their derivatives and sulfonyl urea herbicides.

In an embodiment of the present invention, there is provided a method of controlling unwanted plants, said method comprising applying to the unwanted plants or to their locus a herbicidally effective amount of solid herbicidal compositions comprising:
a) one or more electrolytic herbicides;
b) one or more other herbicides selected from the group comprising pyridine carboxylic acid herbicides, organophosphorus herbicides and sulfonyl urea herbicides; and
c) an inorganic base in an amount sufficient enough to solubilize component a) during dilution.

In another embodiment of the present invention, there is provided a method of controlling unwanted plants in pasture lands, said method comprising applying to the unwanted plants or to their locus a herbicidally effective amount of compositions comprising:
a) one or more electrolytic herbicides;
b) one or more other herbicides selected from the group comprising pyridine carboxylic acid herbicides, organophosphorus herbicides and sulfonyl urea herbicides; and
c) an inorganic base in an amount sufficient enough to solubilize component a) during dilution.

In another embodiment, there is provided a method of controlling unwanted plants, said method comprising a said method comprising applying to the unwanted plants or to their locus a herbicidally effective amount of compositions comprising:
a) one or more electrolytic herbicides;
b) one or more sulfonyl urea herbicide;
c) an inorganic base in an amount sufficient enough to solubilize component a) during dilution.

In an embodiment, the electrolytic herbicide is selected from the group comprising phenoxyacetic acid herbicides, phenoxybutyric acid herbicides, phenoxypropionic herbicides and pyridine carboxylic acid herbicides.

In a preferred embodiment of the present invention, the electrolytic herbicide is selected from phenoxyacetic acid herbicides and pyridine carboxylic acid herbicides.

In another preferred embodiment of the present invention, the phenoxyacetic acid herbicide is 2,4-dichlorophenoxy acetic acid.

In some embodiments of the present invention other herbicides are selected from pyridine carboxylic acid herbicides, organophosphorus herbicides, their derivatives and sulfonyl urea herbicides.

In an embodiment, the compositions according to the present invention is used for post-emergence control of annual and perennial broad-leaved weeds in cereals, maize, sorghum, grassland, established turf, grass seed crops, orchards (pome fruit and stone fruit), cranberries, asparagus, sugar cane, rice, forestry, pasture lands and on non-crop areas.

Inventors of the present invention succeeded in providing stable solid compositions of electrolytic herbicides with various other herbicides. The invention is illustrated by the experiments as exemplified below.

### EXAMPLES

### Example 1

A stable solid composition of 2,4-D, picloram and metsulfuron methyl according to the present invention was prepared as follows:

| | Amount |
|---|---|
| Ingredients | % (wt/wt) |
| 2,4-D acid | 30.0 |
| picloram acid | 10.00 |
| metsulfuron-methyl | 5.00 |
| wetting agent | 3.00 |
| dispersing agent | 3.00 |
| binder | 3.00 |
| defoamer | 0.50 |
| dibasic ammonium | QS |
| phosphate | |

Process: Required quantity of metsulfuron methyl was mixed with pre-weighed quantity of inert, binder and surfactants in the ribbon blender and blend it till homogeneous mixture was formed. The required quantity of picloram acid and 2, 4-D acid was gradually added to the previously micronized metsulfuron methyl mixture and blended them to form a homogeneous mixture. The homogeneous mixture was then blended in a post blender till a uniform mixture was obtained. Required quantity of water (6-8%) was then added to make the dough. It was then charged to basket extrusion granulator to form extruded granules and was then dried in a dryer at 60-65° C.

### Example 2

A stable solid composition of 2,4-D acid, picloram and triclopyr according to the present invention was prepared as follows:

| | Amount |
|---|---|
| Ingredients | % (wt/wt) |
| 2,4-D acid | 10.0 |
| picloram acid | 3.0 |
| triclopyr butotyl | 10.0 |
| dibasic ammonium phosphate | 30.0 |
| dispersing agent | 4.0 |
| binder | 12.0 |
| wetting agent | 2.0 |
| Emulsifier | 3.0 |
| Solvent | 5.0 |
| carrier | QS |

Process: Required quantity of triclopyr butotyl and solvent were mixed along with required quantity of emulsifier until a homogeneous mixture was obtained. The mixture was then adsorbed completely onto a powdered mixture of carrier and binder. Required quantity of picloram acid, 2, 4 D acid, dispersing agent, wetting agent and dibasic ammonium phosphate were added and blended them to get a homogeneous mixture. The mixture was then charged into ribbon blender till a uniform mixture was obtained. A dough was prepared by adding water (7-9%) and then it was subjected to granulator to form granules which was then dried in a dryer at 60-65° C.

### Example 3

A stable solid composition of 2,4-D acid and glufosinate ammonium according to the present invention was prepared as follows. The process of example 1 was followed to prepare the composition.

| | Amount |
|---|---|
| Ingredients | % (wt/wt) |
| 2,4-D acid | 18.0 |
| glufosinate | 25.00 |
| ammonium | |
| wetting agent | 5.00 |
| dispersing agent | 3.00 |
| binder | 5.00 |
| defoamer | 0.50 |
| dibasic ammonium | QS |
| phosphate | |

### Example 4

A stable solid composition of 2,4-D acid, picloram acid and metsulfuron-methyl according to the present invention was prepared as follows. The process of example 1 was followed to prepare the composition.

| | Amount |
|---|---|
| Ingredients | % (wt/wt) |
| 2,4-D acid | 31.8 |
| picloram acid | 9.6 |
| metsulfuron-methyl | 4.5 |
| wetting agent | 3.25 |
| dispersing agent | 3.25 |
| binder | 0.5 |
| defoamer | 0.75 |
| sodium hydrogen | QS |
| phosphate | |

### Example 5

A stable solid composition of 2,4-D acid, picloram acid and triclopyr butotyl according to the present invention was prepared as follows. The process of example 2 was followed to prepare the composition.

| | Amount |
|---|---|
| Ingredients | % (wt/wt) |
| 2,4-D acid | 11.48 |
| picloram acid | 3.16 |
| triclopyr butotyl | 15.75 |
| sodium hydrogen phosphate | 27.16 |
| dispersing agent | 4.20 |
| binder | 0.40 |
| wetting agent | 1.75 |
| Emulsifier | 3.25 |
| Solvent | 5.00 |
| carrier | QS |

### Example 6

A stable solid composition of 2,4-D acid and glufosinate ammonium according to the present invention was prepared as follows. The process of example 1 was followed to prepare the composition.

| | Amount |
|---|---|
| Ingredients | % (wt/wt) |
| 2,4-D acid | 17.60 |
| glufosinate | |
| ammonium | 25.90 |
| wetting agent | 2.75 |
| dispersing agent | 3.25 |
| binder | 0.50 |
| defoamer | 1.0 |
| Potassium phosphate | QS |

Degradation of Metsulfuron Methyl in Compositions with 2,4-D Acid and 2,4-D Sodium Salt: Comparative Study

A comparative study of degradation of metsulfuron methyl in composition of 2,4-D acid and 2,4-D sodium salt in combination with picloram was carried out. The results are summarized in the below table (Table 1):

TABLE 1

| | 2,4-D acid | | 2,4-sodium salt | |
|---|---|---|---|---|
| Active content(gm) | 0 days | 14 days | 0 days | 14 days |
| Picloram acid | 98.96 | 98.05 | 95.65 | 95.59 |
| 2,4-D acid | 333.03 | 325.01 | 325.28 | 328.01 |
| Metsulfuron methyl | 46.06 | 44.42 | 49.78 | 43.88 |

| | % degradation after 14 days | |
|---|---|---|
| Picloram acid | 0.92 | 0.06 |
| 2,4-D acid | 2.41 | 0.84 |
| Metsulfuron methyl | 3.56 | 11.85 |

The study was conducted at 0 days as well as after 14 days at 54° C. (accelerated heat stability conditions). As evident from the table, metsulfuron methyl was highly degraded when it was formulated with 2,4-D sodium salt and picloram acid. It was observed that in the case of formulation of metsulfuron methyl with 2,4-D acid and picloram acid the degradation to be within acceptable limits.

Physical Parameters of a Composition Comprising 2, 4-D Acid, Metsulfuron Methyl and Picloram Acid:

Physical parameters such as suspensibility, dispersibility has been tested for a composition prepared according to the present invention are listed in the below table (Table 2).

TABLE 2

| Active ingredient | Ambient | 14 Day AHS |
|---|---|---|
| picloram acid | 106.5 | 105.5 |
| metsulfuron -methyl | 42.3 | 39.30 |
| 2,4-D acid | 320.5 | 319.6 |
| Suspensibility | | |
| picloram acid | 100.50 | 99.61 |
| metsulfuron -methyl | 100.90 | 99.75 |
| 2,4-D acid | 99.96 | 99.10 |
| dispersibility | 95.25 | 94.80 |
| moisture content | 0.76 | 0.77 |
| wet sieve test | Nil | Nil |

As evident from the Table 2, the physical parameters such as suspensibility and dispersibility of the compositions prepared according to the present invention satisfies the requirement for a stable formulation.

Field Trials:

Field trials were carried out using the compositions prepared according to the present invention as the broad spectrum herbicide at pasture land and recorded the weed control.

At a dose of 0.5 and 1.01/ha after treatment using compositions prepared according to the present invention, very effective weed control was observed demonstrating the bio-efficacy of the new compositions. The sample prepared according to the present invention (Example 1) was compared against tank mix of market samples. The observations at 8 days, 25 days and 32 days after application (DAA) were summarized in below table (Table 3).

TABLE 3
% weed control after 8, 25 and 32 days after application

| | | % Weed control 8 | | % Weed control 25 | | % Weed control 32 | |
|---|---|---|---|---|---|---|---|
| | | DAA | | DAA | | DAA | |
| | Dosage | Bidens | Ipomea | Bidens | Ipomea | Bidens | Ipomea |
| Sample | (l/ha) | pilosa | grandifolia | pilosa | grandifolia | pilosa | grandifolia |
| Example 1 | 0.5 | 83.0 | 73.7 | 95.0 | 90.0 | 100.0 | 98.0 |
| Example 1 | 1.0 | 90.0 | 80.0 | 99.0 | 95.0 | 100.0 | 98.3 |
| Tank mix | 0.5 | 80.0 | 40.0 | 94.0 | 35.0 | 97.3 | 41.7 |
| Tank mix | 1.0 | 90.0 | 65.0 | 97.0 | 85.0 | 98.5 | 92.3 |

From the above result it was thus found that the samples prepared according to the present invention exhibited excellent weed control. The compositions according to the present invention provides acceptable weed control compared to the corresponding tank mix compositions, which could be attributed to the presence of one or more components of the compositions of the present invention, and at least partially, to the presence of the base, preferably an inorganic base, within the compositions of the present invention.

The instant invention is more specifically explained by above examples. However, it should be understood that the scope of the present invention is not limited by the examples in any manner. It will be appreciated by any person skilled in this art that the present invention includes aforesaid examples and further can be modified and altered within the technical scope of the present invention.

1. A solid composition comprising:
a) at least one electrolytic herbicide;
b) at least another herbicide; and
c) a base.

2. The composition of claim 1, wherein said base is added in an amount sufficient enough to solubilize the component a) during dilution of the solid composition.

3. The composition of claim 1, wherein said electrolytic herbicide is selected from phenoxyacetic acid herbicides, phenoxybutyric acid herbicides, phenoxypropionic herbicides, and pyridine carboxylic acid herbicides.

4. The composition of claim 1, wherein said electrolytic herbicide is present in an amount of 1-50% w/w of the total weight of the solid composition.

5. The composition of claim 1, wherein said electrolytic herbicide is a phenoxyacetic acid herbicide.

6. The composition of claim 5 wherein, said phenoxyacetic acid herbicide is 2,4-dichlorophenoxy acetic acid.

7. The composition of claim 1, wherein said another herbicide b) is selected from pyridine carboxylic acid herbicides, organophosphorus herbicides, and sulfonyl urea herbicides.

8. The composition of claim 7, wherein said pyridine carboxylic acid herbicide is selected from picloram acid and triclopyr butotyl.

9. The composition of claim 7, wherein said pyridine carboxylic acid herbicide is present in an amount of 0.1-30% w/w of the total weight of the solid composition.

10. The composition of claim 7, wherein said organophosphorus herbicide is selected from glufosinate, glufosinate-P, glyphosate or a salt or ester thereof.

11. The composition of claim 7, wherein said organophosphorus herbicide is present in an amount of 1-50% w/w of the total weight of the solid composition.

12. The composition of claim 7, wherein said sulfonyl urea herbicide is metsulfuron methyl.

13. The composition of claim 7, wherein said sulfonyl urea herbicide is present in an amount of 0.1-30% w/w of the total weight of the solid composition.

14. The composition of claim 1, wherein said base comprises a base having cations derived from alkali metals or ammonium and counter ions selected from carbonates, phosphates and hydroxides.

15. The composition of claim 1, wherein said base is selected from sodium carbonate, sodium phosphate, sodium hydrogen phosphate, sodium hydroxide, potassium carbonate, potassium phosphate, potassium hydrogen phosphate, potassium hydroxide, ammonium carbonate, diammonium phosphate, ammonium hydrogen phosphate and ammonium hydroxide

16. The composition of claim 1, wherein said composition comprises said base in an amount from about 5% to about 90% by weight of the solid composition.

17. A process for preparing a solid herbicidal composition said process comprising:
a) preparing a mixture of
i) at least one electrolytic herbicide;
ii) at least another herbicide selected from the group consisting of pyridine carboxylic acid herbicides, organophosphorus herbicides and sulfonyl urea herbicides;
iii) a base in an amount sufficient to solubilize component i) during dilution; and
iv) optionally other agrochemical excipients;
b) adding water to provide an extrudable mixture; and
c) extruding said mixture.

18. The process of claim 17, wherein said electrolytic herbicide is selected from phenoxyacetic acid herbicides, phenoxybutyric acid herbicides, phenoxypropionic herbicides and pyridine carboxylic acid herbicides, and said base comprises a base having cations derived from alkali metals or ammonium and counter ions selected from carbonates, phosphates and hydroxides.

19. The process of claim 17, wherein said base is selected from the group consisting of sodium carbonate, sodium phosphate, sodium hydrogen phosphate, sodium hydroxide, potassium carbonate, potassium phosphate, potassium hydrogen phosphate, potassium hydroxide, ammonium carbonate, diammonium phosphate, ammonium hydrogen phosphate, and ammonium hydroxide

20. The process of claim 17, wherein said base is present in an amount from about 5% to about 90% by weight of the solid composition.

21. The process of claim 17, wherein said water is used in an amount of less than 15% by weight of the solid composition.

22. A method of controlling unwanted plants, said method comprising applying to the unwanted plants or to their locus a herbicidally effective amount of a composition according to claim 1.

23. The method of claim 22, wherein said unwanted plants are in pasture lands.

24. The method of claim 22, wherein said electrolytic herbicide is selected from phenoxyacetic acid herbicides, phenoxybutyric acid herbicides, phenoxypropionic herbicides, and pyridine carboxylic acid herbicides, and said b) another herbicide is selected from pyridine carboxylic acid herbicides, organophosphorus herbicides, and sulfonyl urea herbicides.

25. A kit of parts comprising
a) one or more electrolytic herbicides,
b) one or more additional herbicides selected from pyridine carboxylic acid herbicides, organophosphorus herbicides, and sulfonyl urea herbicides;
c) an inorganic base in an amount sufficient to solubilize the one or more electrolytic herbicides of the composition during dilution,
d) other agrochemical excipients; and
e) Instructions that the components of the kit to be applied concurrently, prior or subsequently to another component of the kit.
